(19) United States
(12) Patent Application Publication
(10) Pub. No.: US 2008/0104286 A1
(43) Pub. Date: May 1, 2008

(54) DATA TRANSFER APPARATUS AND DATA TRANSFER METHOD

(76) Inventors: KENICHI ISHII, Ome-shi (JP); Yoshiaki Murano, Fuchu-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/869,150

(22) Filed: Oct. 9, 2007

(30) Foreign Application Priority Data
Oct. 31, 2006 (JP) 2006-297110

(51) Int. Cl. G06F 13/38

(52) U.S. Cl. 710/32

(57) ABSTRACT

According to one embodiment, a data transfer apparatus includes a first device, a transfer unit which controls data transfer between a second device to be connected to the first device and to be controlled thereby, and a control unit which discards data to be transmitted from the second device when the first device decides to stop reception of the data to be transmitted from the second device in a status in which data transfer from the second device to the first device is performed.

### CROSS-REFERENCE TO RELATED APPLICATIONS

This application is based upon and claims the benefit of priority from Japanese Patent Application No. 2006-297110, filed Oct. 31, 2006, the entire contents of which are incorporated herein by reference.

### BACKGROUND

1. Field

One embodiment of the invention relates to an improvement on a data transfer device and a data transfer method which performs data transfer between, for example, a host device and a device connected thereto.

2. Description of the Related Art

As is known well, in performing data transfer between, for example, a host device such as a personal computer (PC) and a storage device such as a hard disk drive (HDD) connected to the host device, sometimes it is desired for the host device to stop the reception of the data to be transmitted from the storage device because of the occurrence of an error, abort, etc.

In such a case, the host device usually generates a reset command to the storage device to instruct the stop of the data transfer; however, while the data keeps on being transmitted from the storage device, since the bus line connecting between the host device and the storage device is used for the data transmission from the storage device, the reset command cannot be transmitted to the storage device.

In other words, the host device can notify the stop of the data transfer by transmitting the reset command to the storage device, only after the completion of the data transmission from the storage device, or after the bus line becomes empty because the data transmission is interrupted once. Therefore, the host device keeps on the reception of the data to be transmitted from the time when the host device decides the stop of the data transfer up to the time when the reset command is actually transmitted to the storage device.

However, the data to be transmitted from the storage device after the host device decides the stop of the data transfer is one to be determined invalid for the host device, the receiving such invalid data in the same way as that for receiving regular data causes useless processing of a system bus and a variety of constituent elements including a memory etc., in the host devices and also brings disadvantage in terms of power consumption.

Jpn. Pat. Appln. KOKAI Publication No. 10-3447 discloses a configuration of a bus bridge device, capable of performing data transfer between two system buses each having independent bus arbitration functions, which terminates a bus cycle to discard the read out data without taking it inside if there is a possibility of an occurrence of a bus timeout error.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a preferred view illustrating an embodiment of the present invention, and a preferred block diagram illustrating for explaining an example of a data transfer system;

FIG. 2 is a preferred block diagram illustrating for explaining an example of a data control unit and a receiving buffer of the data transfer system in the embodiment of the invention;

FIG. 3 is a preferred flowchart illustrating for explaining a part of principal processing operations of the data transfer system in the embodiment of the invention; and

FIG. 4 is a preferred flowchart illustrating for explaining the rest of the principal processing operations of the data transfer system in the embodiment of the invention.

### DETAILED DESCRIPTION

Various embodiments according to the invention will be described hereinafter with reference to the accompanying drawings. In general, according to one embodiment of the invention, a data transfer apparatus includes a first device, a transfer unit which controls data transfer between a second device to be connected to the first device and to be controlled thereby, and a control unit which discards data to be transmitted from the second device when the first device decides to stop reception of the data to be transmitted from the second device in a status in which data transfer from the second device to the first device is performed.

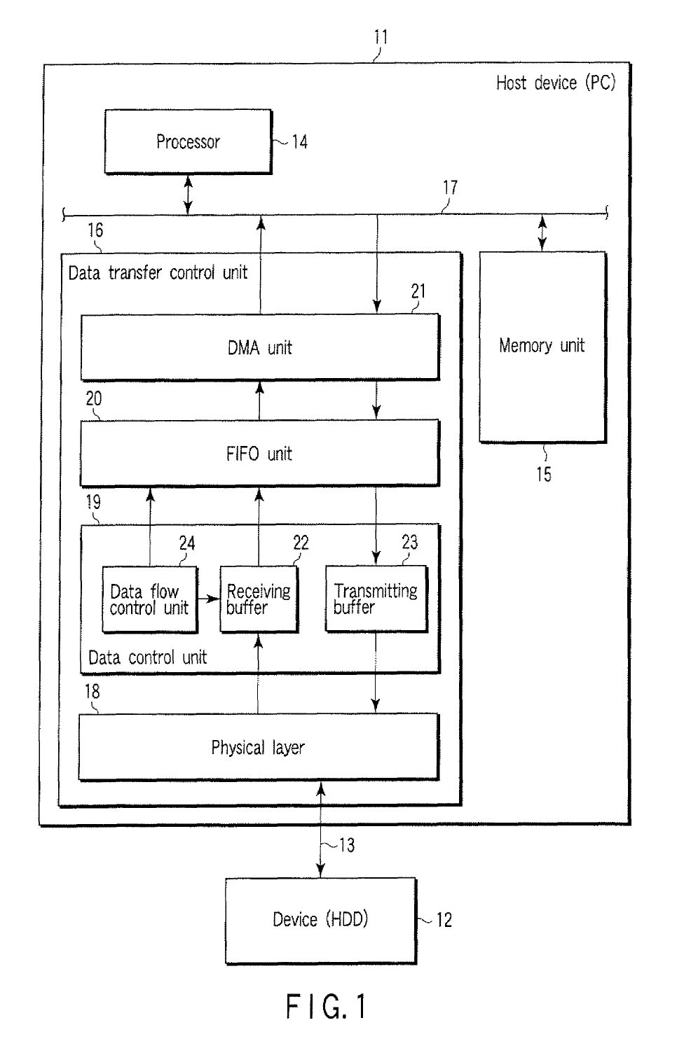

FIG. 1 illustrates an example of a data transfer system to be explained in the embodiment. The data transfer system connects a host device 11 that is composed of, for example, a PC, and a device 12 that is composed of, for example, a HDD with each other via a bus line 13 so as to transfer data.

Among of them, the host device 11 has a processor 14, a memory unit 15, and a data transfer control unit 16, and has a configuration in which these units are connected with one another through a system bus 17. The processor 14 integrally controls various operations to be executed by the host device 11. The memory unit 15 stores a variety of control programs to be executed by the processor 14, provides a work area for the processor 14, and stores information of an image and voice, various items of setting information, control information, etc.

Further, the control unit 16 controls data transfer between the memory unit 15 and the device 12, in a manner based on, for example, the Parallel Advanced Technology Attachment (ATA) specification or Serial ATA specification. That is, the control unit 16 includes a physical layer 18, a data control unit 19, a first-in first-out (FISO) unit 20, and direct memory access (DMA) unit 21.

When the host device 11 receives the data to be transmitted from the device 12, the transmission data from the device 12 is transferred by the DMA unit 21 to the memory unit 15 via the system bus 17 to be written after the transmission data passes through the bus line 13, the physical layer 18, a receiving buffer 22 of the control unit 19, and the FIFO unit 20.

When the host device 11 transmits the data to the device 12r the DMA unit 21 reads out the data from the memory unit 15 via the system bus 17, and the data is transferred to the device 12 via the FIFO unit 20 and a transmitting buffer 23 of the control unit 19, the physical layer 18 and the bus line 13.

Here, the control unit 19 is provided with a data flow control unit 24. When the processor 14 decides to stop the reception of the data to be transmitted from the device 12, the control unit 24 functions so as to set a discard mode to discard (read and discard), without being taken into the FIFO unit 20, the data which is transmitted from the device 12 after the decision time point to be determined invalid for the host device 11.

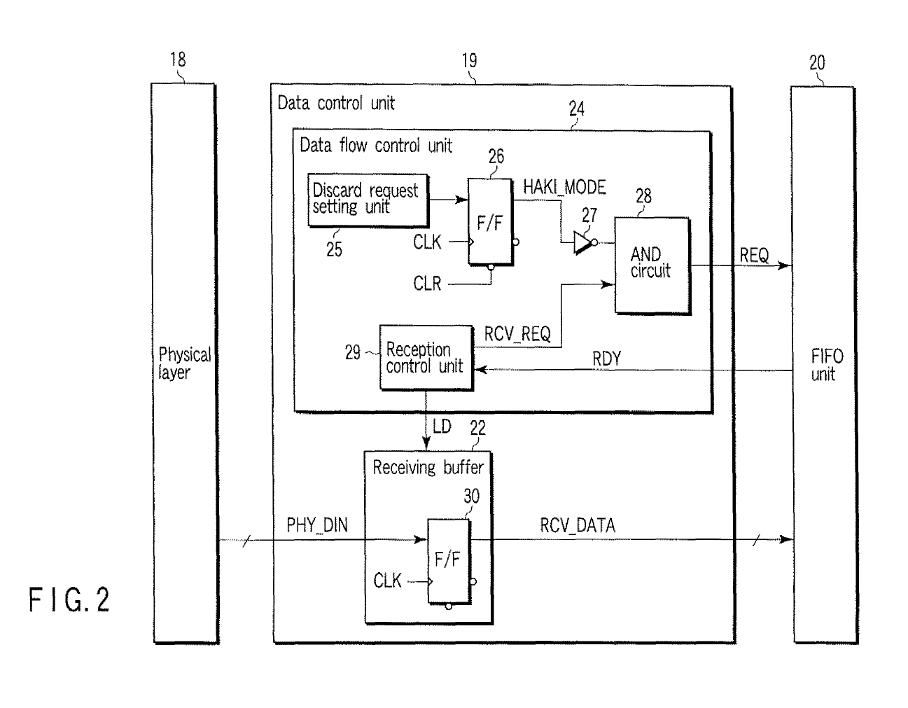

FIG. 2 shows an example of the data flow control unit 24 and the receiving buffer 22 of the data control unit 19. The control unit 24 includes a discard request setting unit 25. The setting unit 25 usually outputs logical 0, and when the processor 14 decides to stop receiving the data to be transmitted from the device 12, it outputs logical 1.

When a reset command to instruct the stop of the data transfer to the device 12 is actually transmitted in a state in which the setting unit 25 outputs logical 1, its output is returned to the logical 0.

The output from the setting unit 25 is stored and output in and from a register 26 in synchronization with a prescribed clock CLK. The content stored in the register 26 may be reset by being supplied a clear signal CLR. The storage-output from the register 26 is supplied to one input end of an AND circuit 28 after being inverted by a NOT circuit 27.

An output from a reception control unit 29 is supplied to the other input end of the AND circuit 28. When the data transmitted from the device 12 is stored in the buffer 22, and the transfer of the data to the FIFO unit 20 is prepared, the control unit 29 outputs a signal of logical 1 to be a reception request signal RCV_REQ to the AND circuit 28, and outputs logical 0 in any other state.

Therefore, usually, in a state in which the setting unit 25 outputs logical 0, logical 1 is supplied to the other input end of the AND circuit 28. Thereby, when the control unit 29 outputs the reception request signal RCV_REQ (logical 1), the AND circuit 28 outputs the signal of logical 1 to be a request signal REQ to request the reception of the data to the FIFO unit 20.

If being in a state that can receive the data, the FIFO unit 20 outputs a signal of logical 1 to be a permission signal RDY to permit the reception of the data. Thereby, the FIFO unit 20 receives and stores the data currently stored in the buffer 22 from an RCV_DATA under the condition that both the request signal REQ (logical 1) and the permission signal RDY (logical 1) are generated.

The buffer 22 has a register 30 to store data PHY_DIN supplied from the physical layer 18, and when a data storage signal LD (logical 1) is supplied from the control unit 29, the buffer 22 stores the data PHY_DIN in the register 30 to output it to the RCV_DATA.

On the contrary, when the processor 14 decides to stop the reception of the data to be transmitted from the device 12, the output from the setting unit 25 becomes logical 1 and it is stored in the register 26, thus, the register 26 generates a signal of logical 1 to be a discard mode signal HAKI_MODE indicating that the system is in the discard mode.

The output from the AND circuit 28 then becomes logical 0 regardless of the output from the control unit 29, and the request signal REQ (logical 1) to request the reception of the data is not generated to the FIFO unit 20. Thereby, the FIFO unit 20 does not receive the data of the RCV_DATA.

However, on the contrary, when both the reception request signal RCV_REQ (logical 1) and the permission signal RDY (logical 1) are generated, the control unit 29 recognizes that the FIFO unit 20 has already received the data. Therefore, outputting a data storage signal LD (logical 1) from the control unit 29 makes the buffer 22 receive the next new data PHY_DIN from the physical layer 18 to store it in the register 30.

In other words, although the stored data in the buffer 22 is continuously updated by the new data PHY_DIN after this, in consequence, the reception data after this should be discarded here.

Thus, since the data transfer system does not perform a series of processing in which the system does not transfer to the FIFO unit 20 to discard the data to be transmitted from the device 12 after deciding to stop the reception of the data to be transmitted from the device 12 and to be determined invalid for the host device 11, and makes the FIFO unit 20 write the data in the memory unit 15 through the DMA unit 21 and the system bus 17, the system may prevent useless processing operations, save a power consumption quantity, and reduce in useless traffic on the system bus 17, in the memory unit 15, etc.

More specifically, when the invalid data is written in the memory unit 15, since the system makes the memory unit 15 execute post-processing such as status check depending on the content of the invalid data, it can prevent such useless post-processing from being executed, and can reduce the load and the deterioration of the system up to a practically sufficient level.

After the reset command to instruct the stop of the data transfer to the device 12 is actually transmitted, since the output from the setting unit 25 is returned to logical 0, the control unit 24 is recovered to the usual state in which the discard mode is released, namely the state that can receive the data transmitted from the device 12.

When the reset command is actually transmitted to the device 12, the device 12 can recognize the stop of the data transfer on the basis of the reset command. Therefore, it is effective to utilize the fact of the actual transmission of the reset command as timing to return the output from the setting unit 25 to logical 0.

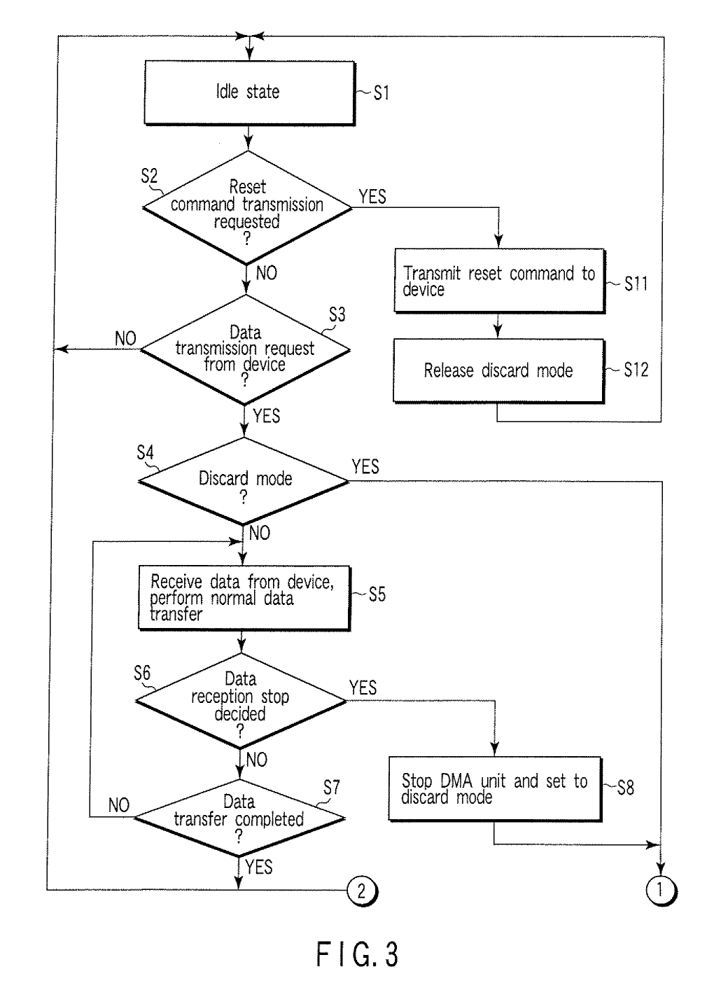

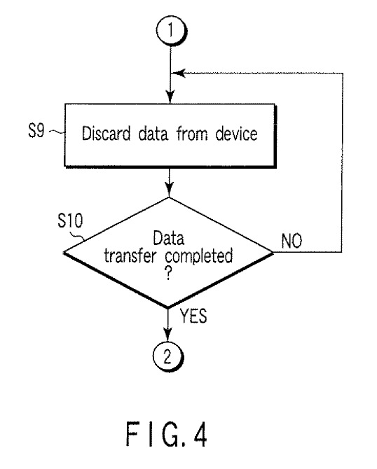

FIG. 3 and FIG. 4 show flowcharts putting together a series of processing operations accompanied by the aforementioned data transfer. At first, in an idle state of the data transfer system (step S1), the processor 14 determines, in step S2, whether or not it is decided to step the reception of the data to be transmitted from the device 12, namely whether or not the request for transmitting the reset command is made to the device 12.

If it is determined that the request for transmitting the reset command to the device 12 has not been made (No), the processor 14 determines whether or not the request for transmitting the data is made from the device 12 to the host device 11 in step S3, and if it is determined that the request has not been made (NO), the processor 14 is returned to the processing in step S1.

If it is determined that the request for transmitting the data has been made from the device 12 to the host device 11 in step S3 (YES), the processor 14 determines, in step S4, whether or not the system is in the discard mode, namely whether or not the register 26 has already output the discard mode signal HAKI_MODE (logical 1).

If it is determined that the system is not in the discard mode (NO), the processor 14 receives the data transmitted from the device 12 in step S5 to write it in the memory unit 15, namely to control each unit so that the device 12 normally performs the data transfer to the host device 11.

After this, the processor 14 determines whether or not it is decided to stop receiving the data to be transmitted from the device 12 in step S6, and if it is determined that the decision has not been made (NO), it is determines whether or not the data transfer from the device 12 to the host device 11 has wholly completed in step S7.

If it is determined that the data transfer has wholly completed (YES), the processor 14 is returned to the processing in step S1, and if it is determined that the data transfer has not wholly completed (NO), the processor 14 is returned to the processing in step S5. The usual data transfer from the device 12 to the host device 11 is processed in the flow of steps S1-S7, during continuation of the data transfer, the processing in steps S5-S7 are repeated.

In step S6, if it is determined to decide stopping the reception of the data to be transmitted from the device 12 (YES), the processor 14 stops the operation of the DMA unit 21, also sets the out put from the setting unit 25 to logical 1, and makes the register 26 output the discard mode signal HAKI_MODE (logical 1) indicating the system being in the discard mode in step S8.

After this step S8, or if it is determined that the system has been already in the discard mode in step S4 (YES), as mentioned above, since the data transfer request signal REQ from the data control unit 19 is forced to be logical 0 by the AND circuit 28, the data which has been transmitted from the device 12 to be stored in the register 30 of the receiving buffer 22 is resulted in discard without being transferred to the FIFO unit 20 in step S9.

The processor 14 then determines whether or not the data transfer from the device 12 to the host device 11 has been wholly completed in step 510, and if it is determined that the data transfer has been wholly completed (YES), the processor 14 is returned to the processing in step S1, and if it is determined that the data transfer has not been wholly completed (NO), the processor 14 is returned to step S9.

In step S2, if it is determined that the request for transmitting the reset command is made to the device 12 (YES), the processor 14 transmits the reset command to the device 12 in step S1. When the reset command is transmitted, the processor 14, in step S12, returns the output from the setting unit 25 to logical 0, sets the output from the register 26 to logical 0 to release the discard mode, and is returned to the processing in step S1.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A data transfer apparatus comprising:
a first device;
a second device configured to be connected to the first device and to be controlled by the first device;
a transfer unit configured to control data transfer between the first and the second devices on the basis of the control by the first device; and
a control unit configured to discard data to be transmitted from the second device when the first device decides to stop reception of the data to be transmitted from the second device in a status in which the transfer unit performs the data transfer from the second device to the first device.

2. The data transfer apparatus according to claim 1, wherein
the transfer unit includes a first in first out unit configured to take in and output the data to be transmitted from the second device; and
the control unit controls so that the data to be transmitted from the second device is not taken in the first in first out unit when the first device decides to stop reception of the data to be transmitted from the second device.

3. The data transfer apparatus according to claim 2, wherein
the control unit controls the first in first out unit so as not to generate a request signal to request reception of the data to be transmitted from the second device when the first device decides to stop reception of the data to be transmitted from the second device.

4. The data transfer device according to claim 2, wherein
the control unit includes:
a register configured to be set in a discard mode when the first device decides to stop reception of the data to be transmitted from the second device; and
a gate unit configured to control the first in first out unit so as not to generate a request signal to request reception of the data to be transmitted from the second device on the basis of an output when the register is set in the discard mode.

5. The data transfer apparatus according to claim 1, wherein
the control unit releases a mode to discard data to be transmitted from the second device when a command to instruct stop of data transfer is transmitted from the first device to the second device.

6. The data transfer apparatus according to claim 5, wherein
the command is transmitted from the first device to the second device when data transfer from the second device to the first device is not performed.

7. The data transfer apparatus according to claim 1, wherein
the first device is a computer and the second device is a storage device.

8. A data transfer apparatus comprising:
a host device:
a storage device configured to be connected to the host apparatus and to be controlled by the host device;
a transfer unit configured to control data transfer between the host device and the storage device on the basis of the control by the host device and to include a first-in first-out unit which takes in to output data transmitted from the storage device;
a register to be set in a discard mode when the host device decides to stop receiving the data to be transmitted from the storage device in a state in which the transfer unit performs the data transfer from the storage device to the host device;
a gate unit configured to discard the data to be transmitted from the storage device by controlling so that the first-in first-out unit does not generate a request signal requesting reception of the data to be transmitted from the storage device on the basis of an output when the register is set in the discard mode; and
a control unit configured to transmit a command to instruct stop of the data transfer to the storage device from the host device when the storage device stops the data transfer to the host device and to release the discard mode which discards the data to be transmitted from the storage device when the command is transmitted.

9. A data transfer method which controls data transfer between a first device and a second device to be connected to the first device and to be controls by the first device, comprising:
making the first device decide to stop reception of data to be transmitted from the second device in a status in which data transfer from the second device to the first device is performed; and
discarding data to be transmitted from the second device when the first device decides to stop the reception of the data transmitted from the second device.

10. The data transfer method according to claim 9, wherein
the discarding the data to be transmitted from the second device controls a gate unit so that the data to be transmitted from the second device is not taken into a first-in first-out unit which takes in to output the data to be transmitted from the second device when the first device decides to stop receiving the data to be transmitted from the second device.

11. The data transfer method according to claim 10, wherein
the discarding the data to be transmitted from the second device controls the gate unit so that the first-in first-out unit does not generate a request signal which requires to receive the data to be transmitted from the second device when the first device decides to stop receiving the data to be transmitted from the second device.

12. The data transfer method according to claim 10, wherein
the discarding the data to be transmitted from the second device controls the gate unit so that the first-in first-out unit does not generate the request signal which requests to receive the data to be transmitted from the second device on the basis of an output from a register to be set in a discard mode when the first device decides to stop receiving the data to be transmitted from the second device.

13. The data transfer method according to claim 9, further comprising,
executing to release a mode which transmits a command, which instructs stop of data transfer, from the first device to the second device when the data transfer from the second device to the first device is stopped, and releases a mode to discard the data to be transmitted from the second device when the command is transmitted.
